(19) United States
(12) Patent Application Publication
(10) Pub. No.: US 2021/0235878 A1
(43) Pub. Date: Aug. 5, 2021

(54) ECO-FRIENDLY BREATHABLE RATTAN BED AND ASSEMBLY METHOD THEREOF

(71) Applicant: ZHEJIANG ZHENDONG LEISURE PRODUCTS CO.,LTD., Linhai (CN)

(72) Inventor: Xiudong LU, Linhai, Zhejiang (CN)

(21) Appl. No.: 16/846,624

(22) Filed: Apr. 13, 2020

(30) Foreign Application Priority Data
Jan. 30, 2020 (CN) 2020100775335

(51) Int. Cl. A47C 17/78; A47C 17/86; A47C 17/66; A47C 19/00; A47C 21/04

(52) U.S. Cl. CPC A47C 17/78; A47C 17/86; A47C 21/04; A47C 19/005; A47C 17/66

(57) ABSTRACT

An eco-friendly breathable rattan bed and an assembly method thereof, comprising a backrest, a bed body support, and a rattan body woven on the bed body support. The rattan body comprises a surface rattan body and a supporting rattan body. The bed body support comprises an upper frame and a lower frame that are fixed through stand columns. The lower frame is internally provided with a cross supporting frame. A surface rattan body locking mechanism is fixed through a plurality of fixing plates arranged on the periphery of the inner surface of the upper frame or directly fixed through the upper frame. The supporting rattan body is closely attached to the surface rattan body locking mechanism. The present disclosure has high elasticity, strength, and air permeability, avoids problems such as difficult disassembly and cleaning of the outer-layer fabric, environmental pollution and health damage, and greatly improves a user's sleep quality.

### TECHNICAL FIELD

This disclosure generally relates to the technical field of home-used beds, and more particularly, to an eco-friendly breathable rattan bed and an assembly method thereof.

### BACKGROUND

With the social development and the improvement of living standards, people's pursuit has differed in all aspects. To stay healthy and relieve the pressures of fast-paced life, people are demanding high quality home-used beds.

There are various beds sold on the market. The most typical one among which is the Simmons spring bed, whose springs are firmly wrapped in padding and are covered in fabric. Although users' different needs can be met through designing the hardness of the spring bed according to the spring's elasticity, the interior of the spring bed is provided with cotton material and its exterior is covered in fabric, inevitably sacrificing its air permeability. The padding can be easily polluted by dirt and mites, and the outer-layer cover is not easy to disassemble and clean, which is not eco-friendly, can affect a user' health, and is troublesome and expensive to replace. Some beds sold on the market are made of rattan materials, but the so-called rattan-weaving only has a decorative function or belongs to an additional bed board, failing to achieve a practical ventilation of the contact surface, and more importantly, not possessing a high-strength elasticity.

### SUMMARY

The purpose of the present disclosure is to provide an eco-friendly breathable rattan bed and an assembly method thereof.

To achieve the above purpose, the present disclosure adopts the following technical solution:

An eco-friendly breathable rattan bed, comprising: a backrest, a bed body support, wherein the bed body support comprises an upper frame and a lower frame that are fixedly connected, wherein the periphery of the inner surface of the upper frame are sequentially provided with a surface rattan body locking mechanism and a supporting rattan body locking mechanism, and a rattan body woven on the bed body support, wherein the rattan body comprises: a surface rattan body for allowing a user to lie on, and a supporting rattan body for supporting the surface rattan body, wherein the supporting rattan body is arranged below the surface rattan body, wherein the surface rattan body locking mechanism fixedly locked the surface rattan body, wherein the supporting rattan body locking mechanism for fixedly locked the supporting rattan body.

In another aspect of the present disclosure, the surface rattan body locking mechanism is a rectangular profile with a clamping groove. The upper frame is provided with a plurality of fixing plates used for fixing the surface rattan body locking mechanism. The surface rattan body locking mechanism is provided with a first clamping groove, and the first clamping groove is arranged opposite to the fixing plates. The end part of each rattan of the surface rattan body is provided with a first convex portion, wherein the diameter of the convex portion is greater than that of the clamping opening of the first clamping groove and is smaller than that of the first clamping groove.

In another aspect of the present disclosure, the length of the supporting rattan body locking mechanism is smaller than that of the surface rattan body locking mechanism. The supporting rattan body locking mechanism is provided with a second clamping groove, and the second clamping groove is opposite to and closely arranged with the side face of the surface rattan body locking mechanism. The end part of each rattan of the supporting rattan body is provided with a second convex portion, and the diameter of the second convex portion is greater than that of the clamping opening of the second clamping groove and is smaller than that of the second clamping groove.

In another aspect of the present disclosure, the surface rattan body locking mechanism and the supporting rattan body locking mechanism are respectively provided with an upper portion and a lower portion, and the first clamping groove and the second clamping groove are formed in the upper portions. The lower portion of the surface rattan body locking mechanism and the lower portion of the supporting rattan body locking mechanism are hollow, and the fixing plates are fixed to the lower portion of the surface rattan body locking mechanism and the lower portion of the supporting rattan body locking mechanism through screws.

In another aspect of the present disclosure, the lower frame comprises a cross supporting frame that is internally arranged for reinforcing the support. The cross supporting frame is provided with a triangular supporting frame, wherein the triangular supporting frame, a stand column and the cross supporting frame are enclosed to form a triangular supporting structure.

In another aspect of the present disclosure, a reinforcing beam is arranged at the lower corner of the upper frame, the upper frame and the lower frame are fixed through the stand columns arranged in the middle and in the corners, and supporting foot mounting columns are arranged at the four inner corners of the upper frame and the lower frame.

In another aspect of the present disclosure, a rattan or soft package for decoration is fixedly arranged around the bed body support formed by the upper frame and lower frame.

An assembly method of the eco-friendly breathable rattan bed, comprising the steps of:
a. Arranging and welding-fixing the upper frame, the lower frame, the stand columns, the cross supporting frame, the triangular supporting frame and the reinforcing beams according to the shape of the bed body;
b. Directly drilling a plurality of regularly-arranged holes on the upper frame, and slightly fixing the surface rattan body locking mechanism and the supporting rattan body locking mechanism by screws, or soldering a plurality of regularly-arranged fixing plates around the inner surface of the upper frame, and slightly fixing the surface rattan body locking mechanism and the supporting rattan body locking mechanism through the screws on the fixing plates, wherein the clamping grooves of the surface rattan body locking mechanism and the supporting rattan body locking mechanism are arranged outward in the same direction, namely, the upper frame being opposite to the fixing plates;
c. Respectively installing the surface rattan body and the supporting rattan body into the surface rattan body locking mechanism and the supporting rattan body locking mechanism, namely, embedding the convex portion of each rattan of the surface rattan body into the first clamping groove, and embedding the convex portion of each rattan of the supporting rattan body into the second clamping groove; after all the four sides of the surface rattan body and the supporting rattan body are respectively embedded into the first clamping groove and the second clamping groove, abutting against the surface rattan body locking mechanism and the supporting rattan body locking mechanism that are arranged on the front and the back of the upper frame by using a spreader until the surface rattan body and the supporting rattan body facing the front and the back are tightened; subsequently, abutting against the surface rattan body locking mechanism and the supporting rattan body locking mechanism that are arranged on the left and the right of the upper frame by using a spreader until the surface rattan body and the supporting rattan body facing the left and the right are tightened; finally, further fixing the upper frame or fixing plates, the surface rattan body locking mechanism and the supporting rattan body locking mechanism by screws;
d. Packaging the edges of the bed assembled in step c, wherein the edge-packaging can adopt rattan or soft packaging, and the four feet of the bed with rattan-packaging are provided with protecting sleeves;
e. Arranging a wood or metal supporting foot in the supporting foot mounting column, and meanwhile, arranging a soft-packaging backrest or a rattan backrest according to the edge-packaging material.

In another aspect of the present disclosure, the convex portion of each rattan of the surface rattan body in step c is embedded in the first clamping groove, and the surface rattan body is wound around the rattan body locking mechanism. Similarly, the convex portion of each rattan of the supporting rattan body is also embedded in the second clamping groove and the supporting rattan body is wound around the supporting rattan body locking mechanism.

In another aspect of the present disclosure, the width of a single rattan of the surface rattan body is 1-1.5 cm, and the width of a single rattan of the supporting rattan body is 3-5 cm.

The technical solution of the present disclosure achieves the following technical effects:
1. The rattan is directly woven on the bed frame and directly replaces the bed board, allowing a user to sleep on the rattan directly. This design achieves an ideal elasticity, air permeability, and comfort. The strengthened structure of the bed frame interacts with the double-layer rattan structure formed by the surface rattan body and the supporting rattan body, which makes the bed surface durable so that the weight of 6-8 adults can be borne.
2. It is easy to clean and free from troubles such as difficult cleaning and easy breeding of mites of cotton materials. It is good for the health of adults and children. In summer, the user can sleep directly on the top of the rattan without using an additional bamboo mat. It is breathable and cool, which can greatly improve the user's sleep quality.

### BRIEF DESCRIPTION OF THE DRAWINGS

FIG. 1 is a three-dimensional diagram illustrating an internal structure of the present disclosure.

FIG. 2 is a partially enlarged diagram of portion A in FIG. 1.

FIG. 3 is a conceptual diagram illustrating the connection between the rattan and the locking mechanism.

FIG. 4 is a conceptual diagram illustrating a side view of FIG. 1.

FIG. 5 is a conceptual diagram illustrating the assembly of the surface rattan body of the present disclosure.

FIG. 6 is a conceptual diagram illustrating the assembly of the supporting rattan body of the present disclosure.

FIG. 7 is a conceptual diagram illustrating an overall effect of the full-rattan-weaving of the present disclosure.

FIG. 8 is a conceptual diagram illustrating an overall effect of the soft-packaging of the present disclosure.

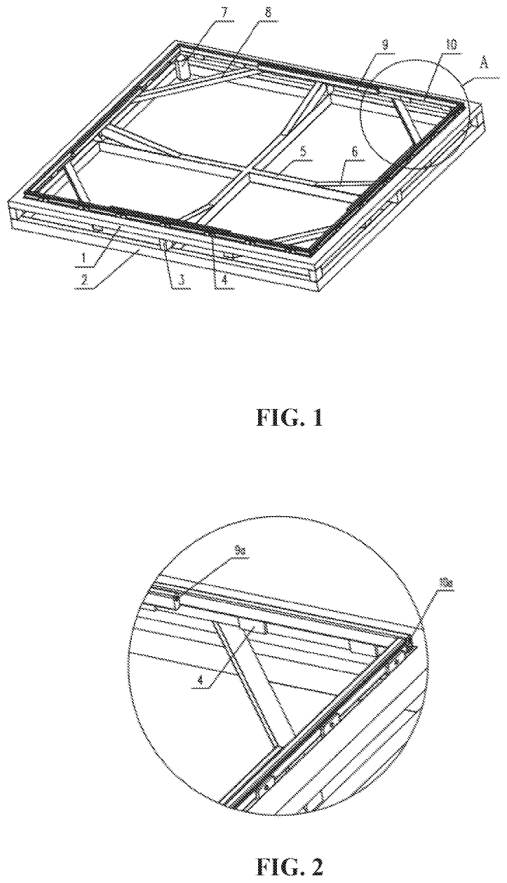

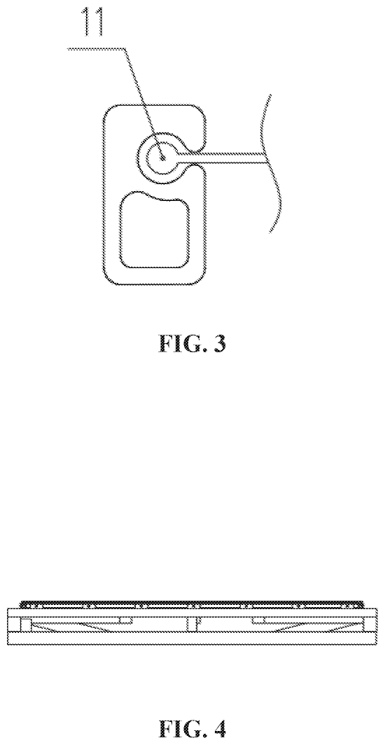

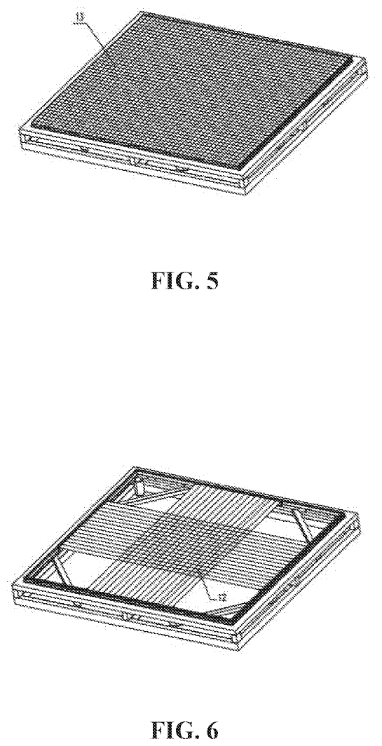

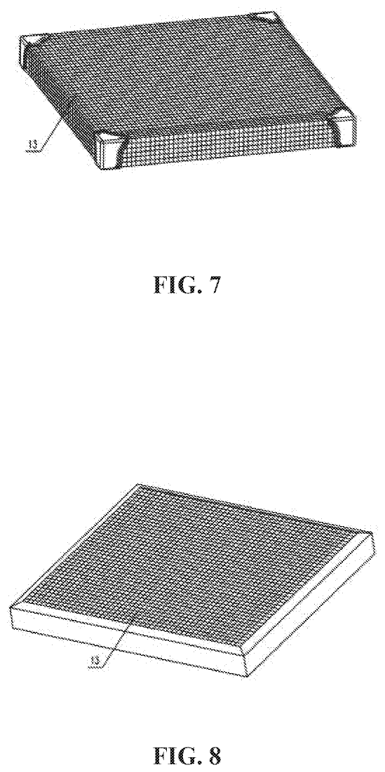

Marking Instructions of the Drawings: 1—Upper Frame, 2—Lower Frame, 3—Stand Column, 4—Fixing Plate, 5—Cross Supporting Frame, 6—Triangular Supporting Frame, 7—Supporting Foot Mounting Column, 8—Reinforcing Beam, 9—Supporting Rattan Body Locking Mechanism, 9a—The Second Clamping Groove, 10—Surface Rattan Body Locking Mechanism, 10a—The First Clamping Groove, 11—Convex Portion, 12—Supporting Rattan Body, 13—Surface Rattan Body.

### DETAILED DESCRIPTION

Drawings and detailed embodiments are combined hereinafter to elaborate the technical solution of the present disclosure.

The eco-friendly breathable rattan bed of the present disclosure comprises a backrest, a bed body support, and a rattan body woven on the bed body support. The backrest is configured according to the style of the bed body, which can be woven with rattan or directly soft-packaged. The rattan body comprises a surface rattan body 13 for allowing a user to lie on and a supporting rattan body 12 for supporting the surface rattan body 13. The surface rattan body 13 is formed by warp-weft weaving a plurality of rattan with a width of 1-1.5 cm, and the supporting rattan body 12 is also formed by warp-weft weaving a plurality of rattan with a width of 3-5 cm. The supporting rattan body 12 is arranged below the surface rattan body 13. The bed body support comprises an upper frame 1 and a lower frame 2 that are fixedly connected, and the periphery of the inner surface of the upper frame 1 are sequentially provided with a surface rattan body locking mechanism 10 for fixedly locking the surface rattan body 13 and a supporting rattan body locking mechanism 9 for fixedly locking the supporting rattan body 12. The surface rattan body locking mechanism 10 and the supporting rattan body locking mechanism 9 are rectangular profiles with clamping grooves. The length of the supporting rattan body locking mechanism 9 is smaller than that of the surface rattan body locking mechanism 10, and the length ratio is about 2:1. The supporting rattan body locking mechanism 9 is arranged in the middle of the surface rattan body locking mechanism 10. The upper frame 1 is provided with a plurality of fixing plates 4 used for fixing the surface rattan body locking mechanism 10. The surface rattan body locking mechanism 10 is provided with a first clamping groove 10a, and the first clamping groove 10a is arranged opposite to the fixing plates 4 before assembly. The end part of each rattan of the surface rattan body 13 is provided with a first convex portion 11, wherein the diameter of the convex portion is greater than that of the clamping opening of the first clamping groove 10a and is smaller than that of the first clamping groove 10a. The supporting rattan body locking mechanism 9 is provided with a second clamping groove 9a, and the second clamping groove 9a is opposite to and closely arranged with the side face of the surface rattan body locking mechanism 10. The end part of each rattan of the supporting rattan body 12 is provided with a second convex portion 11, and the diameter of the second convex portion 11 is greater than that of the clamping opening of the second clamping groove 9a and is smaller than that of the second clamping groove 9a. Through adopting the aforesaid design, the end part of each rattan of the surface rattan body and the supporting rattan body can be easily clamped in the corresponding clamping groove of the surface rattan body locking mechanism 10 and the supporting rattan body locking mechanism 9, and the convex portion of each rattan of the surface rattan body and the supporting rattan body can be prevented from being pulled out of the clamping opening of the corresponding clamping groove.

The surface rattan body locking mechanism 10 and the supporting rattan body locking mechanism 9 are respectively provided with an upper portion and a lower portion, and the first clamping groove 10a and the second clamping groove 9a are formed in the upper portions. The lower portion of the surface rattan body locking mechanism 10 and the lower portion of the supporting rattan body locking mechanism 9 are hollow, and the fixing plates 4 are fixed to the lower portion of the surface rattan body locking mechanism 10 and the lower portion of the supporting rattan body locking mechanism 9 through screws. At this point, they are only slightly fixed, and can be further fixed by using tools after the surface rattan body and the supporting rattan body are tightened.

The lower frame 2 comprises a cross supporting frame 5 that is internally arranged for reinforcing the support. The cross supporting frame 5 is provided with a triangular supporting frame 6, wherein the triangular supporting frame 6, a stand column 3, and the cross supporting frame 5 are enclosed to form a triangular supporting structure. A reinforcing beam 8 is arranged at the lower corner of the upper frame 1, the upper frame 1 and the lower frame 2 are fixed through the stand columns 3 arranged in the middle and in the corners, and supporting foot mounting columns 7 are arranged at the four inner corners of the upper frame 1 and the lower frame 2. In this way, according to the physical mechanical design, all parts of the whole bed frame support each other, achieving a stable and reliable structure. To make the present disclosure aesthetically appealing while protecting human body from being hurt by its corners, a rattan or soft package for decoration is fixedly arranged around the bed body support formed by the upper frame 1 and lower frame 2, thus protecting people especially the children at home from being hurt.

An assembly method of the eco-friendly breathable rattan bed, comprising the steps of:
a. Arranging and welding-fixing the upper frame 1, the lower frame 2, the stand columns 3, the cross supporting frame 5, the triangular supporting frame 6 and the reinforcing beams 8 according to the shape of the bed body;
b. Directly drilling a plurality of regularly-arranged holes on the upper frame 1, and slightly fixing the surface rattan body locking mechanism 10 and the supporting rattan body locking mechanism 9 by screws, or soldering a plurality of regularly-arranged fixing plates 4 around the inner surface of the upper frame 1, and slightly fixing the surface rattan body locking mechanism 10 and the supporting rattan body locking mechanism 9 through the screws on the fixing plates 4, wherein the clamping grooves of the surface rattan body locking mechanism 10 and the supporting rattan body locking mechanism 9 are arranged outward in the same direction, namely, the upper frame 1 being opposite to the fixing plates 4;
c. Respectively installing the surface rattan body 13 and the supporting rattan body 12 into the surface rattan body locking mechanism 10 and the supporting rattan body locking mechanism 9, namely, embedding the convex portion 11 of each rattan of the surface rattan body 13 into the first clamping groove 10a, and embedding the convex portion 11 of each rattan of the supporting rattan body 12 into the second clamping groove 9a; after all the four sides of the surface rattan body 13 and the supporting rattan body 12 are respectively embedded into the first clamping groove 10a and the second clamping groove 9a, abutting against the surface rattan body locking mechanism 10 and the supporting rattan body locking mechanism 9 that are arranged on the front and the back of the upper frame 1 by using a spreader until the surface rattan body 13 and the supporting rattan body 12 facing the front and the back are tightened; the rattan can be easily tightened as it has certain elasticity, and the spreader can be a jack or other pneumatic or hydraulic appliance; similarly, abutting against the surface rattan body locking mechanism 10 and the supporting rattan body locking mechanism 9 that are arranged on the left and the right of the upper frame 1 by using a spreader until the surface rattan body 13 and the supporting rattan body 12 facing the left and the right are tightened; finally, further fixing the upper frame 1 or fixing plates 4, the surface rattan body locking mechanism 10 and the supporting rattan body locking mechanism 9 by screws, thereby achieving a certain bearing capacity; the area of rattan-weaving is the sleeping area of the bed frame, and the main area of the supporting rattan body can merely include its middle portion, thus bearing the corresponding weight and lowering the cost;
d. Packaging the edges of the bed assembled in step c, wherein the edge-packaging can adopt rattan or soft packaging, and the four feet of the bed with rattan-packaging are provided with protecting sleeves;
e. Arranging a wood or metal supporting foot in the supporting foot mounting column 7, and meanwhile, arranging a soft-packaging backrest or a rattan backrest according to the edge-packaging material.

The convex portion 11 of each rattan of the surface rattan body 13 in step c is embedded in the first clamping groove 10a, and the surface rattan body 13 is wound around the rattan body locking mechanism 10. Similarly, the convex portion 11 of each rattan of the supporting rattan body 12 is also embedded in the second clamping groove 9a, and the supporting rattan body 12 is wound around the supporting rattan body locking mechanism 9. In this way, the rattan and the upper surface of the locking mechanism form a friction force. The rattan body is stretched and tightened by using tools and then locked by screws. According to this, the effect of the friction force can be improved, making the convex portion of the rattan more difficult to be pulled out of the groove of the locking mechanism. Thus, a higher elasticity of the surface rattan body and the supporting rattan body can be ensured, achieving a firm fixation and a strong bearing capacity.

The embodiment is only an explanation but not a limitation of the present disclosure. After reading the specification, those skilled in the art can make modifications to the embodiment according to actual needs without paying creative labor. Therefore, modifications made within the spirit and principles of the disclosure shall fall into the scope of the present disclosure.

What is claimed is:

1. An eco-friendly breathable rattan bed, comprising:
a backrest,
a bed body support, wherein the bed body support comprises an upper frame and a lower frame that are fixedly connected, wherein the periphery of the inner surface of the upper frame are sequentially provided with a surface rattan body locking mechanism and a supporting rattan body locking mechanism, and
a rattan body woven on the bed body support, wherein the rattan body comprises:
a surface rattan body for allowing a user to lie on, and
a supporting rattan body for supporting the surface rattan body, wherein the supporting rattan body is arranged below the surface rattan body, wherein the surface rattan body locking mechanism fixedly locked the surface rattan body, wherein the supporting rattan body locking mechanism for fixedly locked the supporting rattan body.

2. The eco-friendly breathable rattan bed of claim 1, wherein the surface rattan body locking mechanism is a rectangular profile with at least one clamping groove, wherein the upper frame is provided with a plurality of fixing plates used for fixing the surface rattan body locking mechanism, wherein the surface rattan body locking mechanism is provided with a first clamping groove, and the first clamping groove is arranged opposite to the fixing plates, wherein the end part of each rattan of the surface rattan body is provided with a first convex portion, wherein the diameter of the convex portion is greater than that of the clamping opening of the first clamping groove and is smaller than that of the first clamping groove.

3. The eco-friendly breathable rattan bed of claim 2, wherein the length of the supporting rattan body locking mechanism is smaller than that of the surface rattan body locking mechanism, wherein the supporting rattan body locking mechanism is provided with a second clamping groove, and the second clamping groove is opposite to and closely arranged with the side face of the surface rattan body locking mechanism, wherein the end part of each rattan of the supporting rattan body is provided with a second convex portion, and the diameter of the second convex portion is greater than that of the clamping opening of the second clamping groove and is smaller than that of the second clamping groove.

4. The eco-friendly breathable rattan bed of claim 3, wherein the surface rattan body locking mechanism and the supporting rattan body locking mechanism are respectively provided with an upper portion and a lower portion, and the first clamping groove and the second clamping groove are formed in the upper portions, wherein the lower portion of the surface rattan body locking mechanism and the lower portion of the supporting rattan body locking mechanism are hollow, and the fixing plates are fixed to the lower portion of the surface rattan body locking mechanism and the lower portion of the supporting rattan body locking mechanism through screws.

5. The eco-friendly breathable rattan bed of claim 1, wherein the lower frame comprises a cross supporting frame that is internally arranged for reinforcing the support, wherein the cross supporting frame is provided with a triangular supporting frame, wherein the triangular supporting frame, the stand column and the cross supporting frame are enclosed to form a triangular supporting structure.

6. The eco-friendly breathable rattan bed of claim 1, wherein a reinforcing beam is arranged at the lower corner of the upper frame, the upper frame and the lower frame are fixed through the stand columns arranged in the middle and in the corners, and supporting foot mounting columns are arranged at the four inner corners of the upper frame and the lower frame.

7. The eco-friendly breathable rattan bed of claim 6, wherein a rattan or soft package for decoration is fixedly arranged around the bed body support formed by the upper frame and lower frame.

8. An assembly method of the eco-friendly breathable rattan bed, comprising the steps of:
arranging and welding-fixing an upper frame, an lower frame, stand columns, a cross supporting frame, a triangular supporting frame, and reinforcing beams according to a shape of a bed body;
directly drilling a plurality of regularly-arranged holes on the upper frame, and slightly fixing a surface rattan body locking mechanism and a supporting rattan body locking mechanism by screws, or soldering a plurality of regularly-arranged fixing plates around an inner surface of the upper frame, and slightly fixing the surface rattan body locking mechanism and the supporting rattan body locking mechanism through the screws on the fixing plates, wherein the clamping grooves of the surface rattan body locking mechanism and the supporting rattan body locking mechanism are arranged outward in the same direction such that the upper frame being opposite to the fixing plates;
respectively installing the surface rattan body and the supporting rattan body into the surface rattan body locking mechanism and the supporting rattan body locking mechanism to form an assembled bed, comprising:
embedding a convex portion of each rattan of the surface rattan body into a first clamping groove,
embedding a convex portion of each rattan of the supporting rattan body into a second clamping groove,
abutting against the surface rattan body locking mechanism and the supporting rattan body locking mechanism that are arranged on the front and the back of the upper frame using a spreader until the surface rattan body and the supporting rattan body facing the front and the back are tightened,
abutting against the surface rattan body locking mechanism and the supporting rattan body locking mechanism that are arranged on the left and the right of the upper frame using a spreader until the surface rattan body and the supporting rattan body facing the left and the right are tightened,
fixing the upper frame or the fixing plates, the surface rattan body locking mechanism and the supporting rattan body locking mechanism by screws;
packaging edges of the assembled bed, wherein edge-packaging material adopts rattan or soft packaging, and four feet of the assembled bed with rattan-packaging are provided with protecting sleeves;
arranging a wood or metal supporting foot in supporting foot mounting column, and arranging a soft-packaging backrest or a rattan backrest according to the edge-packaging material.

9. The assembly method of the eco-friendly breathable rattan bed of claim 8, wherein the convex portion of each rattan of the surface rattan body is embedded in the first clamping groove, and the surface rattan body is wound around the rattan body locking mechanism, wherein the convex portion of each rattan of the supporting rattan body is also embedded in the second clamping groove, and the supporting rattan body is wound around the supporting rattan body locking mechanism.

10. The assembly method of the eco-friendly breathable rattan bed of claim 9, wherein the width of a single rattan of the surface rattan body is 1-1.5 cm, and the width of a single rattan of the supporting rattan body is 3-5 cm.
